(19) United States
(12) Patent Application Publication
(10) Pub. No.: US 2021/0270966 A1
(43) Pub. Date: Sep. 2, 2021

(54) OBJECT DETECTING DEVICE

(71) Applicant: Mitsubishi Electric Corporation, Tokyo (JP)

(72) Inventors: Hiroaki Inoue, Tokyo (JP); Masahiro Kawai, Tokyo (JP); Shohei Tsukamoto, Tokyo (JP); Masaharu Imaki, Tokyo (JP)

(73) Assignee: Mitsubishi Electric Corporation, Tokyo (JP)

(21) Appl. No.: 17/074,862

(22) Filed: Oct. 20, 2020

(30) Foreign Application Priority Data
Mar. 2, 2020 (JP) 2020-034599

(51) Int. Cl. G01S 17/10; G01S 7/4865

(52) U.S. Cl. CPC G01S 17/10; G01S 7/4865

(57) ABSTRACT

An object detecting device is configured of a laser beam generating unit that generates a laser beam, a light receiving unit that outputs a received light signal based on a laser beam reflected from a detection target object, a distance calculating unit that calculates a distance to the detection target object based on a time required from an emission of the laser beam until a reception of the received light signal, and a wave height value calculating unit that obtains an approximate straight line based on inclinations of a rise and a fall of a waveform of the received light signal at a set threshold, and calculates a wave height value of the received light signal based on the approximate straight line, wherein information regarding the detection target object is collected based on the wave height value, in addition to the distance being calculated.

### BACKGROUND OF THE INVENTION

### Field of the Invention

The present application relates to the field of an object detecting device.

### Description of the Related Art

A distance measuring device that, with a light wave, a sound wave, or an electromagnetic wave as a search wave, irradiates a detection target object and measures a distance based on a wave reflected from the detection target object, is already known. Also, an object detecting device, in addition to measuring distance, carries out a measurement of a reflected wave height value in order to collect other information regarding a detection target object. Because of this, for example, a white line on a road surface can be detected.

An optical distance measuring device such that an optical pulse is projected onto a target object and reflected scattered light is received, whereby time required from the projection of the optical pulse until receiving the reflected pulse is measured, and a distance to the measurement target object is measured using the measured time, is already known as a method of measuring distance to a distance measurement target object. Herein, accuracy of detecting the time at which the reflected pulse is received has a large effect on distance measurement accuracy.

In order to improve detection accuracy, the height value of the reflected wave is measured. A received optical pulse detected by a wave height value detecting circuit is differentiated using a differentiating circuit, an output differential signal is further integrated, a peak value is detected, the detected peak value is corrected as a wave height value of the received optical pulse, and the distance to the distance measurement target object is calculated using the corrected measured time (see, for example, Patent document JP4771796B2).

Also, as a measuring method whereby a height of an obstacle is detected in addition to a distance to an object adopted as a detection target, an object detecting device is also mounted in, for example, a vehicle, an object existing at a height at which a ranging sensor is attached is adopted as a reference obstacle, and the height value of a wave reflected by the reference obstacle is adopted as a reference wave height value and compared with a wave height value of the object adopted as the detection target, whereby a relative height of the object adopted as the detection target with respect to the reference obstacle is calculated (see, for example, Patent document JP6412399B2).

However, the existing pulse signal wave height value detecting circuit in JP4771796B2 is such that in addition to the original distance measuring function, a detecting circuit is added in order to detect a wave height value, because of which the circuit scale increases. For example, a peak hold circuit used for wave height value detection is of a configuration wherein current is caused to flow into a capacitor in a forward direction only using the capacitor, a diode, and a switch, the capacitor is charged by the flowing current, and a wave height value voltage is held. When measurement of the held wave height value is completed, resetting of the voltage holding function is carried out by connecting an electrode on one side of the capacitor to the ground by the switch to discharge the charge. As this kind of circuit configuration is adopted, a high speed switching operation and switch switching control from an exterior are needed, and there is a problem in that the circuit scale increases, and the device increases in size.

Also, the existing object detecting device in JP6412399B2 is such that when detecting an object at a short distance, the wave height value of a received reflected wave becomes saturated, because of which the wave height value cannot be calculated, meaning that when a received output is saturated in this way, the wave height value is estimated using a first time, which is a time at which the wave height value exceeds a certain threshold, a second time, which is a time at which the wave height value drops below the threshold, and a search wave transmission time. When estimating a wave height value using this kind of method, there is spreading of the search wave, meaning that when measuring, for example, a flat road surface and an inclined road surface, an inclination of a rise and an inclination of a fall of the received output of the inclined road surface are small with respect to those of the flat road surface. Because of this, there is a problem in that estimated wave height values differ even when the first time, the second time, and the search wave transmission time are the same, and an error occurs with respect to a true value in accordance with a received waveform.

### SUMMARY OF THE INVENTION

The present application has been made to solve the above problem, and an object of the present application is to provide an object detecting device such that measurement accuracy can be improved, without newly adding a peak hold circuit, or a device for the purpose, in order to calculate a wave height value utilized in improving accuracy of measuring search information including information regarding a distance to a detection target object.

An object detecting device disclosed in the present application includes a search wave output unit that emits a pulse-form search wave toward a detection target object, a reflected wave receiving unit that receives a reflected wave that is the search wave reflected by the detection target object, a distance calculating unit that calculates a distance to the detection target object based on a time required from an emission of the search wave until a reception of the reflected wave, and a wave height value calculating unit that obtains an approximate straight line based on an inclination of a rise and/or a fall of a waveform of the reflected wave at a set threshold, and calculates a wave height value of the reflected wave based on the approximate straight line.

The object detecting device disclosed in the present application can keep a difference with respect to an actual wave height value of a reflected wave small by a wave height value being calculated using approximate straight lines obtained based on inclinations of a rise and a fall of a waveform of the reflected wave, and can improve accuracy of measuring a distance to a necessary detection target object and of other information collection.

The foregoing and other objects, features, aspects, and advantages of the present application will become more apparent from the following detailed description of the present application when taken in conjunction with the accompanying drawings.

### BRIEF DESCRIPTION OF THE DRAWINGS

FIG. 1 is a functional block diagram showing a schematic configuration of a whole of an object detecting device according to a first embodiment;

FIG. 2 is a schematic view showing a schematic configuration of an optical system of the object detecting device according to the first embodiment;

FIG. 3 is a drawing showing a configuration of a MEMS mirror used in the object detecting device according to the first embodiment;

FIGS. 4A and 4B are drawings showing waveforms of current providing power for driving the MEMS mirror in the first embodiment;

FIG. 5 is a drawing showing a method for irradiation scanning with a laser beam in the first embodiment;

FIG. 6 is a drawing showing a hardware configuration of a control device in the first embodiment;

FIG. 7 is a drawing illustrating a method for detecting a distance to a detection target object in the first embodiment;

FIGS. 8A and 8B are drawings showing a time chart of a laser drive signal and a reflected light in the first embodiment;

FIG. 9 is a drawing showing a configuration of a threshold time calculating circuit that calculates a time at a threshold voltage based on a reflected light in the first embodiment;

FIGS. 10A and 10B are drawings showing a time chart of a laser drive signal pulse width when a light detector output is not saturated and a received light signal waveform in the first embodiment;

FIGS. 11A and 11B are drawings showing a time chart of a laser drive signal pulse width when the light detector output is saturated and a received light signal waveform in the first embodiment;

FIG. 12 is a drawing for describing a method for estimating a wave height value of a reflected light when the light detector output is not saturated in the first embodiment;

FIGS. 13A and 13B are drawings for describing a difference between a wave height value according to approximate straight lines and a wave height value of a reflected light in the first embodiment;

FIG. 14 is a drawing for describing a method for estimating a wave height value of a reflected light when the light detector output is saturated in the first embodiment;

FIG. 15 is a drawing for describing a method for estimating a wave height value of a reflected light when a detection target object is inclined in a second embodiment;

FIGS. 16A and 16B are drawings showing a time chart of a laser drive signal pulse width when the light detector output is not saturated and a case wherein a reflected light waveform is a Gaussian distribution in a third embodiment;

FIGS. 17A and 17B are drawings showing a time chart of a laser drive signal pulse width when the light detector output is saturated and a case wherein a reflected light waveform is a Gaussian distribution in the third embodiment; and

FIG. 18 is a drawing for describing a correlation between a half-width at half-maximum of a reflected light waveform and an approximate straight line in the third embodiment.

### DETAILED DESCRIPTION OF THE PREFERRED EMBODIMENTS

### First Embodiment

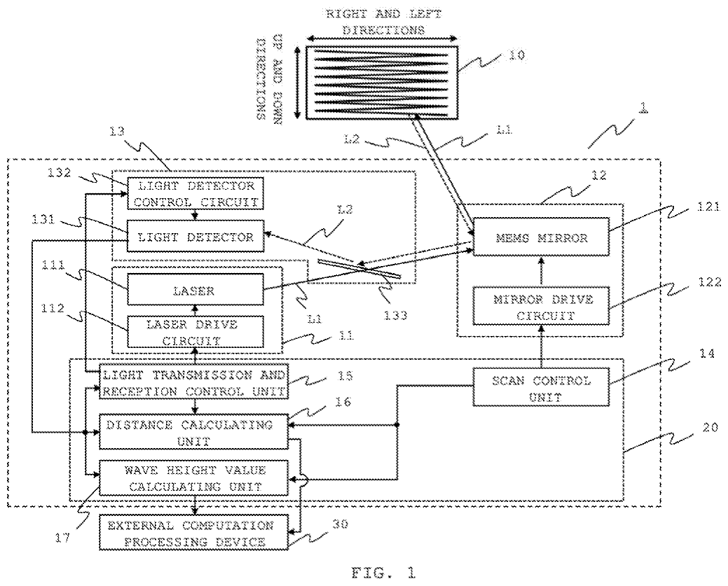

FIG. 1 is a functional block diagram showing a schematic configuration of a whole of an object detecting device according to a first embodiment.

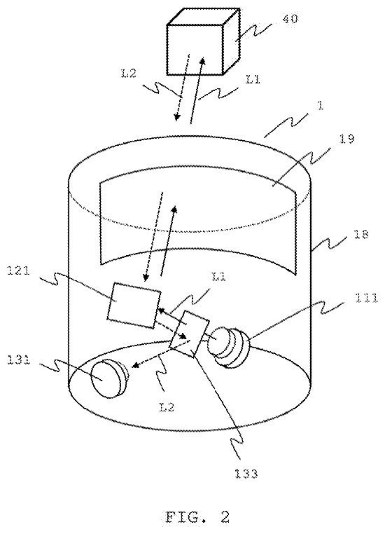

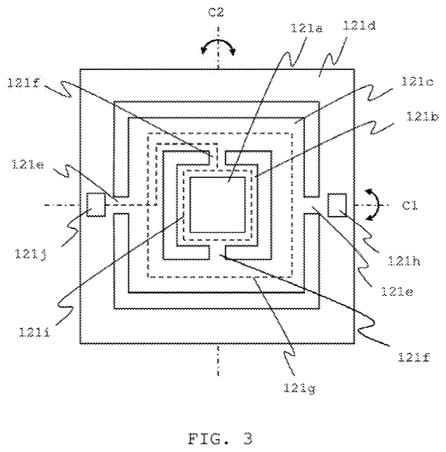

FIG. 2 is a schematic view showing a schematic configuration of an optical system of the object detecting device according to the first embodiment. FIGS. 3 to 14 are drawings for describing details of a configuration and an operation of the object detecting device according to the first embodiment.

In the first embodiment, an object detecting device 1 wherein a laser is utilized as a search wave is described as an example. The object detecting device 1 is mounted in an own vehicle, irradiates a position ahead of the own vehicle by carrying out a two-dimensional scanning with a laser beam L1, and collects search information including information regarding a distance to a detection target object 40 existing ahead of the own vehicle.

Next, a configuration of the whole of the object detecting device 1 according to the first embodiment will be described, using FIG. 1. The object detecting device 1 is configured of a laser beam generating unit 11 that generates the laser beam L1, which is a search wave, a scanning unit that scans with the laser beam L1 to irradiate the detection target object 40, a scan control unit 14 that controls the scanning unit 12, a light receiving unit 13 that receives a reflected laser beam L2 from the detection target object 40, and outputs a received light signal that is a reflected wave, and a control unit 20 that controls each unit. The control unit 20 includes the scan control unit 14, a light transmission and reception control unit 15, a distance calculating unit 16, and a wave height value calculating unit 17. The light transmission and reception control unit 15 transmits commands to a laser drive circuit 112 and a light detector control circuit 132. The distance calculating unit 16 calculates a distance to an object based on the emitted laser beam L1 and a received light signal reflected from the detection target object 40. The wave height value calculating unit 17 calculates a wave height value of a received light signal. A search wave output unit corresponds to the laser beam generating unit 11, which emits a laser beam L1 that is a search wave, and a reflected wave receiving unit corresponds to the light receiving unit 13, which receives reflected laser beam L2.

Also, as shown in the schematic view of FIG. 2, the optical system of the object detecting device 1 is configured of a laser 111, a movable mirror 121 that carries out a scanning with the emitted laser beam L1, a permeable window 19 that is provided in a housing 18 and through which the laser beam L1 is caused to permeate, a light collecting mirror 133 that is irradiated from the permeable window 19 and which collects light reflected from the detection target object 40, and a light detector 131 that detects light reflected by the light collecting mirror 133.

Hereafter, details of an operation of each unit configuring the object detecting device 1 will be described.

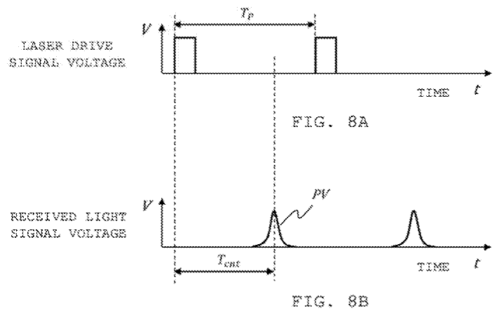

The laser beam generating unit 11 is configured of the laser 111 and the laser drive circuit 112. The laser beam L1 is emitted, directed ahead of the own vehicle, from the laser 111. As shown in FIGS. 8A, 8B the laser drive circuit 112 generates a pulse-form output signal (a laser drive signal) that switches to an on-state in a pulse cycle Tp, based on a command signal from the light transmission and reception control unit 15 of the control unit 20, to be described hereafter. When a laser drive signal transmitted from the laser drive circuit 112 switches to an on-state, the laser 111 generates the laser beam L1, which has a near infrared wavelength, and the laser beam L1 is emitted toward the movable mirror 121 of the scanning unit 12. The laser beam L1 emitted from the laser 111 permeates the light collecting mirror 133 disposed between the laser 111 and the scanning unit 12.

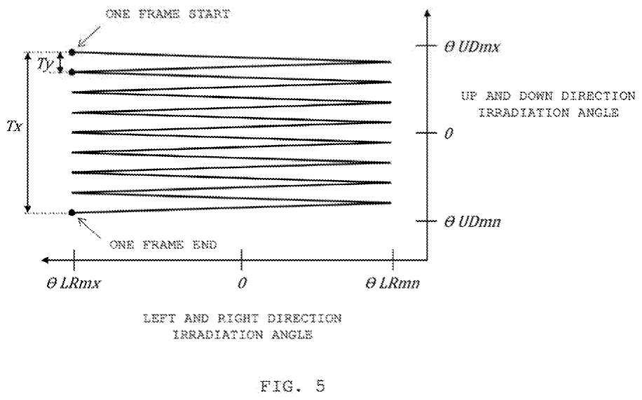

The scanning unit 12 is configured of the movable mirror 121 and a mirror drive circuit 122. The movable mirror 121 changes an irradiation angle of the laser beam L1 by scanning, based on a command from the scan control unit 14 of the control unit 20. In this embodiment, the scanning unit 12 causes the irradiation angle of the laser beam L1, which irradiates a position ahead of the own vehicle, to change in left and right directions and up and down directions with respect to a direction of travel (an irradiation center line) of the own vehicle, as shown in FIG. 5. As shown in the schematic view of the optical system in FIG. 2, the laser beam L1 emitted from the laser 111 is reflected by the movable mirror 121 after permeating the light collecting mirror 133, permeates the permeable window 19 provided in the housing 18, and irradiates an irradiation region 10 ahead of the own vehicle at an irradiation angle in accordance with an angle of the movable mirror 121.

In this embodiment, a micro-electro-mechanical systems (MEMS) mirror 121 is adopted as the movable mirror 121. The MEMS mirror 121 includes a rotation mechanism that causes a mirror 121a to rotate around a first shaft C1 and a second shaft C2, which are perpendicular to each other, as shown in FIG. 3. The MEMS mirror 121 includes a rectangular plate form inner frame 121b in which the mirror 121a is provided, a rectangular annular intermediate frame 121c disposed on an outer side of the inner frame 121b, and a rectangular plate form outer frame 121d disposed on an outer side of the intermediate frame 121c. The outer frame 121d is fixed to a main body of the MEMS mirror 121.

The outer frame 121d and the intermediate frame 121c are linked by two left and right first torsion bars 121e having torsional elasticity. The intermediate frame 121c is twisted and rotates with respect to the outer frame 121d centered on the first shaft C1, which connects the two first torsion bars 121e. When the intermediate frame 121c twists to either one side around the first shaft C1, the irradiation angle of the laser beam L1 changes to an upper side or a lower side. The intermediate frame 121c and the inner frame 121b are linked by two upper and lower second torsion bars 121f having torsional elasticity. The inner frame 121b is twisted and rotates with respect to the intermediate frame 121c centered on the second shaft C2, which connects the two second torsion bars 121f. When the inner frame 121b twists to either one side around the second shaft C2, the irradiation angle of the laser beam L1 changes to a left side or a right side.

An annular first coil 121g that follows the form of the frame is provided in the intermediate frame 121c, and a first electrode pad 121h connected to the first coil 121g is provided in the outer frame 121d. Also, an annular second coil 121i that follows the form of the frame is provided in the inner frame 121b, and a second electrode pad 121j connected to the second coil 121i is provided in the outer frame 121d. Although not shown in the drawings, a permanent magnet is provided in the MEMS mirror 121. When a positive side or negative side current flows through the first coil 121g, a Lorentz force that twists the intermediate frame 121c to either one side around the first shaft C1 acts owing to an interaction with the permanent magnet, and an angle of twisting caused by the Lorentz force is proportional to a magnitude of the energizing current. Similarly, when a positive side or negative side current flows through the second coil 121i, a Lorentz force that twists the inner frame 121b to either one side around the second shaft C2 acts owing to an interaction with the permanent magnet, and an angle of twisting caused by the Lorentz force is proportional to a magnitude of the energizing current.

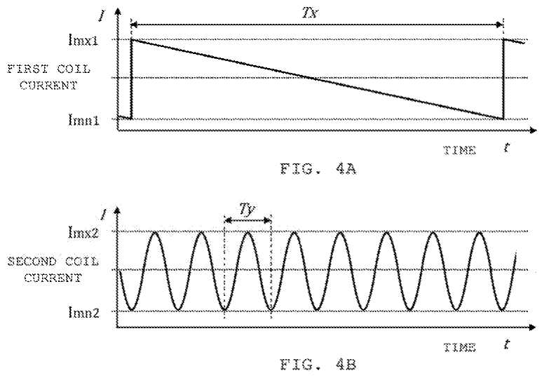

As shown in a time chart of FIG. 4A, the mirror drive circuit 122 supplies a current that fluctuates between a positive first maximum current value Imx1 and a negative first minimum current value Imn1 in a first cycle Tx to the first coil 121g via the first electrode pad 121h, in accordance with a command signal from the scan control unit 14. The first cycle Tx is a cycle equivalent to one frame of a two-dimensional scan. A fluctuating waveform of the current is taken to be, for example, a sawtooth wave or a triangular wave. As shown in FIG. 5, scanning with the laser beam L1 is carried out in the first cycle Tx between an up and down direction maximum irradiation angle θUDmx, which corresponds to the positive first maximum current value Imx1, and an up and down direction minimum irradiation angle θUDmn, which corresponds to the negative first minimum current value Imn1. The first maximum current value Imx1 and the first minimum current value Imn1 may be caused to vary in accordance with a traveling state of the own vehicle.

As shown in a time chart of FIG. 4B, the mirror drive circuit 122 supplies a current that fluctuates between a positive second maximum current value Imx2 and a negative second minimum current value Imn2 in a second cycle Ty to the second coil 121i via the second electrode pad 121j, in accordance with a command signal from the scan control unit 14. The second cycle Ty, being set to a value smaller than that of the first cycle Tx, is set to a value that is the first cycle Tx divided by a number of left and right direction reciprocating scans in one frame. A fluctuating waveform of the current is taken to be, for example, a sinusoidal wave or a rectangular wave. As shown in FIG. 5, scanning with the laser beam L1 is carried out in the second cycle Ty between a left and right direction maximum irradiation angle θLRmx, which corresponds to the positive second maximum current value Imx2, and a left and right direction minimum irradiation angle θLRmn, which corresponds to the negative second minimum current value Imn2. The second maximum current value Imx2 and the second minimum current value Imn2 may be caused to vary in accordance with the traveling state of the own vehicle.

The light receiving unit 13 is a portion that receives the reflected laser beam L2, which is the laser beam L1 reflected from the detection target object 40 ahead of the own vehicle. The light receiving unit 13 is configured of the light detector 131, the light detector control circuit 132, and the light collecting mirror 133. As shown in FIG. 2, the reflected laser beam L2 reflected by the detection target object 40 ahead of the own vehicle permeates the permeable window 19 and is reflected by the movable mirror 121, after which the reflected laser beam L2 is further reflected by the light collecting mirror 133, and detected by the light detector 131.

The light detector 131 includes a light receiving device for which, for example, an avalanche photodiode (APD) is used, and outputs a received light signal PV in accordance with the received reflected laser beam L2. The light detector control circuit 132 controls an operation of the light detector 131 based on a command signal from the light transmission and reception control unit 15. The received light signal PV output from the light detector 131 is input into the light transmission and reception control unit 15, the distance calculating unit 16, and the wave height value calculating unit 17 of the control unit 20.

Although an APD is used as the light detector 131 in the first embodiment, the light detector 131 may also be a light receiving device for which a single photon avalanche diode (SPAD) or a SPAD array is used, and is not limited to these.

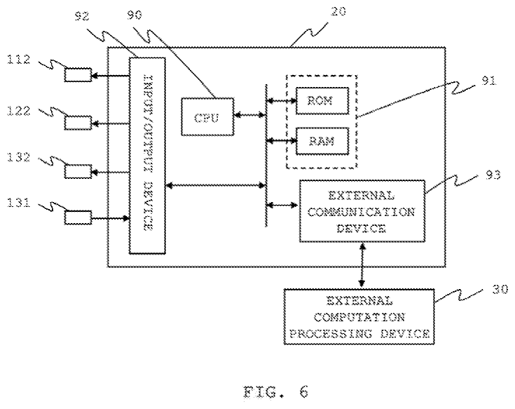

The control unit 20 is configured of the scan control unit 14, the light transmission and reception control unit 15, the distance calculating unit 16, and the wave height value calculating unit 17. Each function of the control unit 20 is realized by a processing circuit included in the control unit 20. Specifically, as shown in FIG. 6, the control unit 20 includes as processing circuits a computation processing device (computer) 90 formed of a central processing unit (CPU), a storage device 91 that exchanges data with the computation processing device 90, an input/output device 92 that inputs or outputs an external signal into or from the computation processing device 90, and an external communication device 93 that carries out a communication of data with an external computation processing device 30 of the object detecting device 1.

The computation processing device 90 may be dedicated hardware, or may be a CPU (also called a central processing device, a microprocessor, a microcomputer, a processor, or a DSP) that executes a program stored in the storage device 91. Also, various kinds of logic circuit and various kinds of signal processing circuit, including an application specific integrated circuit (ASIC), an integrated circuit (IC), a digital signal processor (DSP), and a field programmable gate array (FPGA), may be included. Also, the computation processing device 90 may be a multiple of the same kind of component or a multiple of differing kinds of component, wherein each process is allocated and executed. A random access memory (RAM) configured so as to be able to read and write data from and into the computation processing device 90, and a read-only memory (ROM) configured so as to be able to read data from the computation processing device 90, are included as the storage device 91. Various kinds of storage device, including, for example, a flash memory and an electrically erasable programmable read-only memory (EEPROM), may be used as the storage device 91.

When the computation processing device 90 is dedicated hardware, a single circuit, a composite circuit, a programmed processor, a parallel-programmed processor, an ASIC, an FPGA, or a combination thereof, for example, is applied as the computation processing device 90. Functions of each of the scan control unit 14, the light transmission and reception control unit 15, the distance calculating unit 16, and the wave height value calculating unit 17 may be realized individually by the computation processing device 90, or the functions of each unit may be realized collectively by the computation processing device 90.

When the computation processing device 90 is a CPU, the functions of each of the scan control unit 14, the light transmission and reception control unit 15, the distance calculating unit 16, and the wave height value calculating unit 17 are realized by software, firmware, or a combination of software and firmware. Software and firmware are described as processing programs, and stored in the storage device 91. The computation processing device 90 realizes the functions of each unit by reading and executing a processing program stored in the storage device 91. That is, the control unit 20 includes the storage device 91 for storing processing programs that, when executed by the computation processing device 90, result in the execution of a processing step of importing the received light signal PV of the light receiving unit 13, and transmitting the acquired received light signal PV to the light transmission and reception control unit 15, the distance calculating unit 16, and the wave height value calculating unit 17, a processing step of generating a light transmission and reception control signal in the light transmission and reception control unit 15, a processing step of processing a scan control signal from the scan control unit 14 in the distance calculating unit 16, a processing step of calculating a wave height value in the wave height value calculating unit 17, and a processing step of outputting a data processing result to the external computation processing device 30. Also, it can also be said that these processing programs cause a computer to execute procedures or methods of the scan control unit 14, the light transmission and reception control unit 15, the distance calculating unit 16, and the wave height value calculating unit 17. Herein, a non-volatile or volatile semiconductor memory such as a RAM, a ROM, a flash memory, an EPROM, or an EEPROM, a magnetic disk, a flexible disk, an optical disk, a compact disk, a minidisk, or a DVD is applied as the storage device 91.

The laser drive circuit 112, the mirror drive circuit 122, the light detector control circuit 132, and the light detector 131 are connected to the input/output device 92, and a communication circuit and an input/output port that carry out a transmission and a reception of data and control commands between the above-mentioned components and the computation processing device 90 are included. The external communication device 93 carries out communication with an external device of the external computation processing device 30.

Further, the functions of each functional unit 14 to included in the control unit 20 are executed by the computation processing device 90 executing software (a program) stored in the storage device 91, and collaborating with the storage device 91, the input/output device 92, and the external communication device 93, which are other hardware components of the control unit 20. Setting data for determining distance used by each functional unit 14 to 17 are stored in the storage device 91 as one portion of the software (program). Hereafter, each function of the control unit 20 will be described in detail.

The light transmission and reception control unit 15 transmits a command signal to the laser drive circuit 112, causing the pulse-form laser beam L1 with the pulse cycle Tp to be output. Also, the light transmission and reception control unit 15 transmits a command signal to the light detector control circuit 132, causing the received light signal PV detected by the light detector 131 to be output. Furthermore, the light transmission and reception control unit 15 also transmits command signals to the distance calculating unit 16 and the wave height value calculating unit 17.

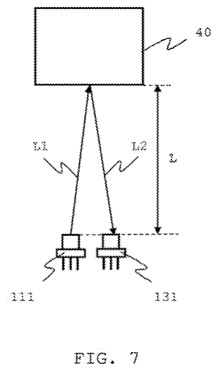

The distance calculating unit 16 calculates the distance to the detection target object 40 existing at an irradiation angle θ based on the emitted laser beam L1, the received light signal PV, and the irradiation angle θ. As shown in FIG. 7, the laser beam L1 emitted from the laser 111 is reflected by the detection target object 40, which is a distance L ahead, and the reflected laser beam L2 is detected by the light detector 131, which is the distance L behind. FIGS. 8A and 8B show a relationship between a laser drive signal voltage V, which drives the laser 111, and a received light signal voltage V of the reflected laser beam L2, which is the emitted laser beam L1 reflected by the detection target object 40 and received by the light detector 131. A time Tcnt from a point at which the laser drive signal voltage V rises until a peak value of the received light signal voltage V is measured corresponds to a time in which the laser beam L1 and received laser beam L2 reciprocate over the distance L between the laser 111 and light detector 131 and the detection target object 40. Consequently, the distance L to the detection target object 40 can be calculated by multiplying the time Tcnt by a light speed C, and dividing by two.

The distance calculating unit 16 measures a time from a point at which the laser 111 starts an emission of the pulse-form laser beam L1 in response to a laser drive signal from the laser drive circuit 112 to a point at which the light detector 131 of the light receiving unit 13 outputs the received light signal voltage V as a light receiving time T. Further, the distance calculating unit 16 calculates a value that is the light receiving time T multiplied by the light speed C and divided by two as the distance L to the detection target object 40 existing at the irradiation angle θ at the point at which the laser beam L1 is emitted. When no received light signal voltage V is being output from the light receiving unit 13, the distance calculating unit 16 determines that no detection target object 40 corresponding to the irradiation angle θ at that point has been detected, and does not calculate the distance L. Subsequently, the distance calculating unit 16 transmits a distance calculation result to the external computation processing device 30.

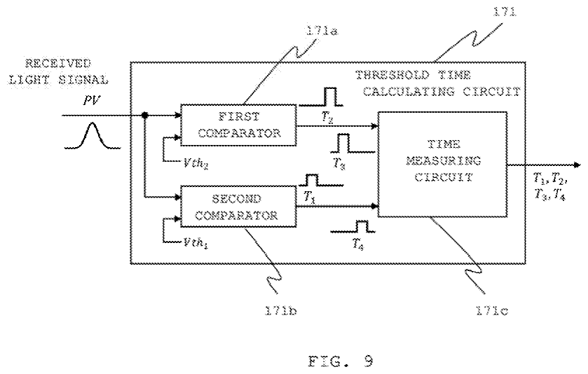

The wave height value calculating unit 17 measures an intensity of the reflected laser beam L2 based on a magnitude of the received light signal voltage V output from the light detector 131 of the light receiving unit 13. Two threshold voltages Vth are set with respect to the received light signal voltage V, and the wave height value is estimated based on a voltage difference thereof and a time difference. Specifically therefore, as a preliminary stage for estimating the wave height value, the received light signal PV is processed using a threshold time calculating circuit 171 provided in the wave height value calculating unit 17 as shown in FIG. 9. Firstly, the received light signal voltage V from the light detector 131 is input into each of two comparators 171a and 171b. The received light signal voltage V input into the first comparator 171a is compared with a threshold voltage Vth₁, and a rectangular first output waveform is generated. Also, the received light signal voltage V input into the second comparator 171b is compared with a threshold voltage Vth₂, and a rectangular second output waveform is generated. Next, rise times T₁ and T₂ and fall times T₃ and T₄ of the first output waveform and the second output waveform respectively are calculated by a time measuring circuit 171c, with a point at which the laser drive signal voltage V that causes the laser beam L1 to be emitted starts to rise as a reference.

A determination of whether or not the received light signal voltage V is saturated is carried out in accordance with a value of a time difference T₃−T₂ between the rise time T₂ at the threshold voltage Vth₂ and the fall time T₃ at the threshold voltage Vth₂. Specifically, whether or not the received light signal voltage V is saturated depends on which relationship the value of T₃−T₂ satisfies, that of Equation (1) or Equation (2). Herein, TI indicates a laser drive signal pulse width, Ts indicates a normal reset time of the light detector 131, and α indicates a correction coefficient. The received light signal voltage V is affected by noise and the like, and the waveform thereof is corrupted, because of which the correction coefficient α is experimentally obtained in advance, and added to the laser drive signal pulse width TI.

When an amount of incident light (the intensity of the reflected laser beam L2) exceeds a maximum charge amount, the received light signal voltage V becomes saturated, and time is needed until the light detector 131 is reset normally (the normal reset time). The normal reset time Ts is a time until a charge accumulated in the light detector 131 is released, and depends on the light detector 131.

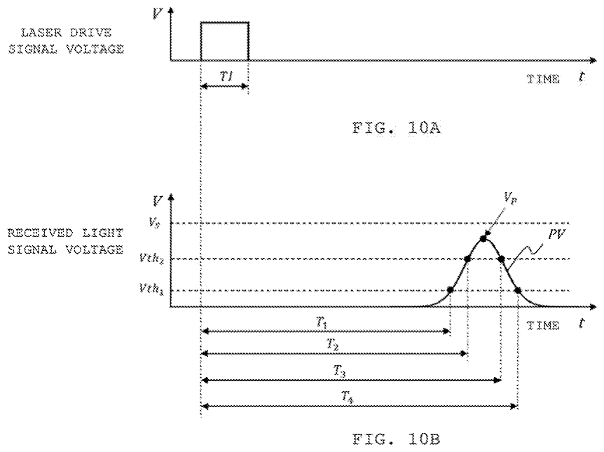

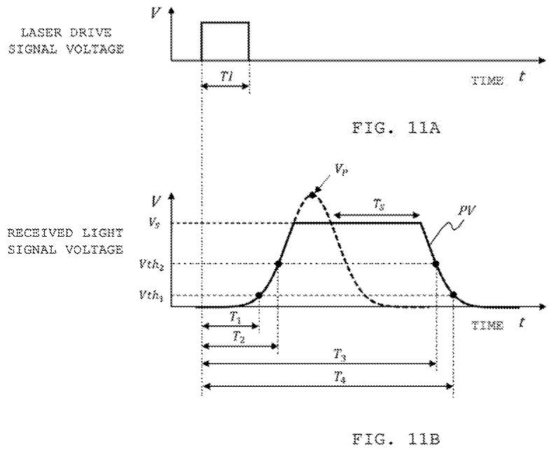

When the value of T₃−T₂ satisfies the relationship of Equation (1), it is determined that a wave height value Vp of the received light signal PV has not reached a saturation voltage Vs, and the received light signal voltage V is in a non-saturated state (FIGS. 10A, 10B). Meanwhile, when the value of T₃−T₂ satisfies the relationship of Equation (2), it is determined that the wave height value Vp of the waveform of the received light signal PV has exceeded the saturation voltage Vs, and the received light signal voltage V is in a saturated state (FIGS. 11A, 11B).

T3−T2≤TI+Ts+α (1)

T3−T2>TI+Ts+α (2)

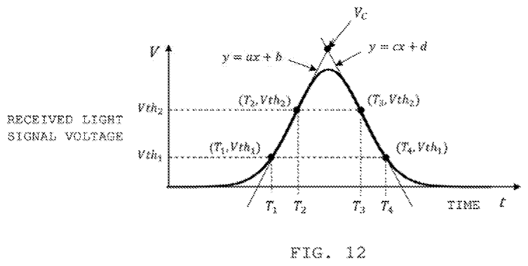

Next, a method of estimating the wave height value Vp when the received light signal voltage V is in a non-saturated state will be described. When the waveform of the received light signal PV and the threshold voltages Vth₁ and Vth₂ are defined, the relationships between time and voltage at each threshold voltage are (T₁, V₁), (T₂, V₂), (T₃, V₃), and (T₄, V₄), as shown in FIG. 12. Herein, V₁ and V₄=Vth₁, and V₂ and V₃=Vth₂.

When approximate straight lines having inclinations corresponding to the rise and the fall of the received light signal PV are defined as y=ax+b and y=cx+d respectively, the inclinations and intercepts can be obtained using Equation (3).

$$a = \frac{{V}_{2} - {V}_{1}}{{T}_{2} - {T}_{1}} , \\ b = \frac{{T}_{2} {V}_{1} - {T}_{1} {V}_{2}}{{T}_{2} - {T}_{1}} , \\ c = \frac{{V}_{1} - {V}_{2}}{{T}_{4} - {T}_{3}} , \\ d = \frac{{T}_{4} {V}_{2} - {T}_{3} {V}_{1}}{{T}_{4} - {T}_{3}} \qquad ( 3 )$$

Based on the inclinations and intercepts, an intersection point Vc of the two approximate straight lines can be obtained as in Equation (4).

$${V}_{C} = \frac{a d - b c}{a - c} = \frac{( {V}_{2} - {V}_{1} ) ( {T}_{4} {V}_{2} - {T}_{3} {V}_{1} ) - ( {T}_{2} {V}_{1} - {T}_{1} {V}_{2} ) ( {V}_{1} - {V}_{2} )}{( {V}_{2} - {V}_{1} ) ( {T}_{4} - {T}_{3} ) - ( {V}_{1} - {V}_{2} ) ( {T}_{2} - {T}_{1} )} \qquad ( 4 )$$

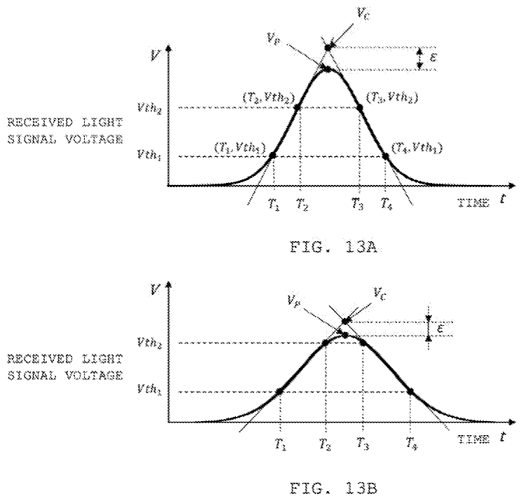

Although an error occurs between the obtained intersection point Vc of the approximate straight lines and the wave height value Vp, which is the actual peak value of the waveform of the received light signal PV, this error ε has a correlation with the inclinations of the approximate straight lines, because of which the error ε can be experimentally obtained in advance. When the width of the waveform of the received light signal PV is small, as shown in FIG. 13A, the inclinations of the approximate straight lines increase, and the error ε between the intersection point Vc of the approximate straight lines and the wave height value Vp increases, but when the width of the waveform of the received light signal PV is large, as shown in FIG. 13B, the inclinations of the approximate straight lines decrease, and the error ε between the intersection point Vc of the approximate straight lines and the wave height value Vp decreases. Based on this relationship, an error correction table that corrects the error ε between the inclinations of the approximate straight lines and the intersection point Vc thereof and the wave height value Vp is compiled in advance based on a theoretical calculation value or experiment, and it is presumed that a value obtained by subtracting the error amount from the intersection point Vc of the approximate straight lines is the wave height value.

Continuing, a method of estimating the wave height value Vp when the received light signal voltage V is in a saturated state will be described. When the waveform of the received light signal PV and the threshold voltages Vth₁ and Vth₂ are defined, the relationships between the time T and the received light signal voltage V at each threshold are (T₁, V₁), (T₂, V₂), (T₃, V₃), and (T₄, V₄), in the same way as when the received light signal voltage V is in a non-saturated state.

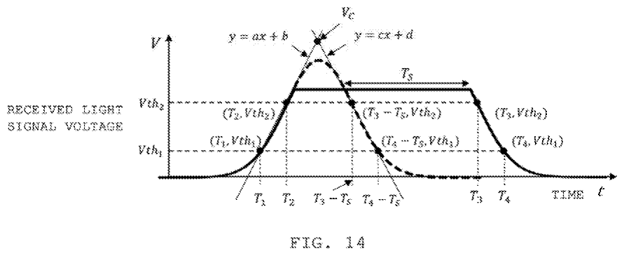

When two approximate straight lines are set using values T₃−Ts and T₄−Ts, wherein the normal reset time Ts (the time until a saturated charge in the light detector is released) is subtracted from the times T₃ and T₄, as fall coordinates of the waveform of the received light signal PV, as shown in FIG. 14, the intersection point Vc of the two approximate straight lines can be obtained in the following way.

$$V c = \frac{\begin{matrix}( {V}_{2} - {V}_{1} ) ( ( {T}_{4} - T s ) {V}_{2} - ( {T}_{3} - T s ) {V}_{1} ) - \\ ( {T}_{2} {V}_{1} - {T}_{1} {V}_{2} ) ( {V}_{1} - {V}_{2} )\end{matrix}}{( {V}_{2} - {V}_{1} ) ( {T}_{4} - {T}_{3} - 2 T s ) - ( {V}_{1} - {V}_{2} ) ( {T}_{2} - {T}_{1} )} \qquad ( 5 )$$

Although the error occurs between the obtained intersection point Vc of the approximate straight lines and the wave height value Vp, this error ε has a correlation with the inclinations of the approximate straight lines, because of which the same error correction table as when the received light signal voltage V is not saturated is used, or another error correction table obtained experimentally in advance can be used. It is presumed that a value obtained by subtracting the error amount from the intersection point Vc of the approximate straight lines is the wave height value.

Consequently, calculation of a wave height value can be carried out with high accuracy, at a low cost and with a small scale circuit configuration, by using the heretofore described methods implemented by the wave height value calculating unit 17. Furthermore, when the intensity of reflected light is high and the output of the light detector is saturated when measuring a short distance, the wave height value can be calculated accurately, even when detecting the wave height value is difficult with an existing circuit configuration.

By irradiating a position ahead of the own vehicle by scanning with a laser beam, as shown in FIG. 1, accurately calculating a wave height value based on a received light signal, and distinguishing a difference in an amount of light reflected from a detection target object in a scanning plane, the existence or otherwise of a white line on a road surface and a position thereof, for example, can be accurately discerned.

In this way, the object detecting device according to the first embodiment is such that, in addition to having a function of measuring the distance to a detection target object, a wave height value can be calculated with high accuracy by approximate straight lines corresponding to the inclinations of the rise and the fall of a received light signal waveform being set, and the wave height value being estimated and corrected based on the intersection point of the approximate straight lines, and a difference in an amount of reflected light from the detection target object can be distinguished by using the wave height value, because of which the object detecting device can also be applied to, for example, discerning a white line on a road surface.

### Second Embodiment

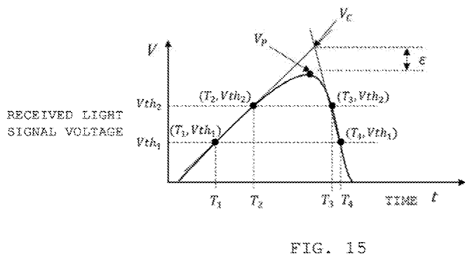

FIG. 15 is a drawing showing a waveform of the received light signal PV, which is a wave height value calculation target of an object detecting device according to a second embodiment. Since a configuration of the object detecting device 1 according to the second embodiment is the same as that of the first embodiment shown in FIG. 1, a description will be omitted. A difference from the first embodiment is that a wave height value estimating method is different.

This embodiment is such that when the detection target object 40 is inclined, the waveform of the received light signal PV is asymmetrical, and the inclinations of an approximate straight line of the rise and an approximate straight line of the fall of the waveform of the received light signal PV are different, as shown in FIG. 15. When the approximate straight line inclinations differ, the error ε occurs in the estimated wave height value Vp, because of which there is a need to determine the existence or otherwise of an inclination of the detection target object 40, and to add a correction. Herein, a difference between an inclination a of the approximate straight line corresponding to the rise and an inclination c of the approximate straight line corresponding to the fall of the waveform of the received light signal PV is obtained, it is determined that the detection target object 40 is not inclined when the relationship of Equation (6) below is established, and it is determined that the detection target object 40 is inclined when the relationship of Equation (6) is not established. Herein, a constant β is, for example, an arbitrary constant, and is a value obtained experimentally. When it is determined that the detection target object 40 is inclined, a correction value obtained from a theoretical calculation value or an experimental value for correcting the error ε between the intersection point Vc and the actual wave height value Vp in accordance with the difference in the inclinations of the two approximate straight lines is added to the error correction table for the intersection point Vc of the two approximate straight lines and the wave height value Vp shown in the first embodiment.

|a−c|≤β (6)

Consequently, even when the waveform of the received light signal changes due to the inclination and the form of the detection target object, the wave height value can be estimated with high accuracy by the degree of inclination of the detection target object being determined based on the difference between the inclination of the rise and the inclination of the fall of the received light signal waveform, and a correction being added.

In this way, the object detecting device according to the second embodiment is such that, in addition to having the same functions as in the first embodiment, the wave height value can be calculated with high accuracy even when the detection target object is inclined, or the external form differs.

### Third Embodiment

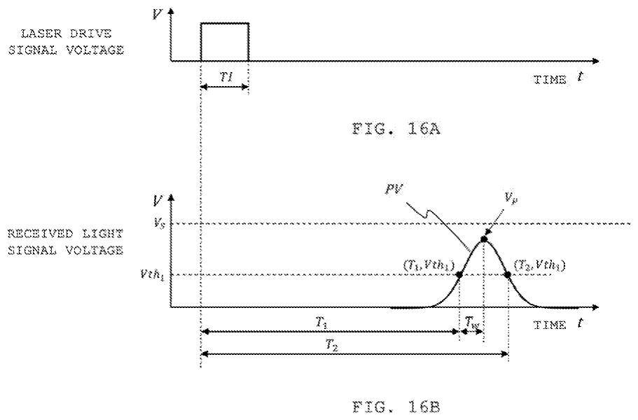

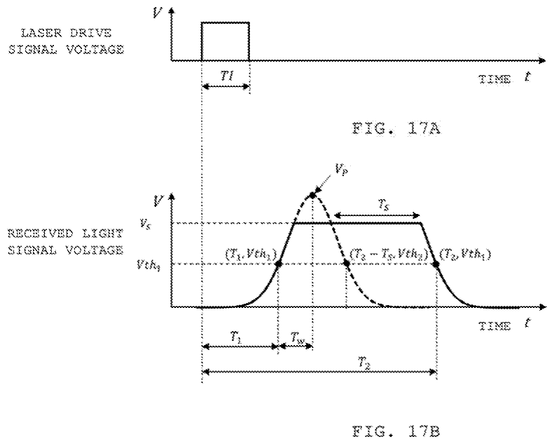

FIGS. 16A, 16B and 17A, 17B are drawings showing a waveform of the received light signal PV, which is a wave height value calculation target of an object detecting device according to a third embodiment. Since a configuration of the object detecting device 1 according to the third embodiment is the same as that of the first embodiment shown in FIG. 1, a description will be omitted. A difference from the first embodiment is that a wave height value calculating method is different.

In this embodiment, the wave height value Vp is calculated assuming that the waveform of the received light signal PV conforms to a Gaussian function (a normal distribution function). A Gaussian function is shown in Equation (7). Herein, A is a maximum value, t is a central position of a peak value, and w is a half-width at half-maximum.

$$f ( x ) = A \cdot exp ( - ln 2 \cdot \frac{{( x - t )}^{2}}{{w}^{2}} ) \qquad ( 7 )$$

Rewriting Equation (7) results in Equation (8), whereby the maximum value A can be obtained. Herein, A represents the wave height value Vp of the waveform of the received light signal PV.

$$A = \frac{f ( x )}{exp ( - ln 2 \cdot \frac{{( x - t )}^{2}}{{w}^{2}} )} \qquad ( 8 )$$

Specifically, the threshold voltage Vth and the time T thereof are input into Equation (8), and the wave height value Vp is obtained. As shown in FIG. 16B, the times T₁ and T₂ from the start of the rise of the light source drive signal voltage V until the threshold voltage Vth are converted into a time Tw from a central position of the waveform of the received light signal PV. Either of the threshold voltage Vth₁ and the threshold voltage Vth₂ may be used as the threshold voltage Vth. Herein, a case in which the threshold voltage Vth₁ is used will be described.

The time Tw from the central position can be expressed by Equation (9) using the times T₁ and T₂. Equation (9) is a case wherein the received light signal voltage V is not saturated.

$$Tw = - \frac{( T 2 - T 1 )}{2} \qquad ( 9 )$$

When the received light signal voltage V is saturated, the time Tw from the central position can be expressed by Equation (10) using the times T₁ and T₂, as shown in FIG. 17B.

$$Tw = - \frac{( T 2 - T s - T 1 )}{2} \qquad ( 10 )$$

Herein, when x=Tw, t=0, and f(x)=Vth₁ in Equation (8), the wave height value Vp can be expressed by Equation (11).

$${V}_{P} = \frac{{V}_{t h 1}}{exp ( - ln 2 \cdot \frac{T {w}^{2}}{{w}^{2}} )} \qquad ( 11 )$$

The wave height value calculating method according to this embodiment is such that as an error occurs in the wave height value Vp due to the waveform of the received light signal PV, the error needs to be corrected. Herein, the received light signal waveform is estimated and corrected by at least one item of information from among the inclination of the rise and the inclination of the fall of the received light signal waveform being used in the error correction.

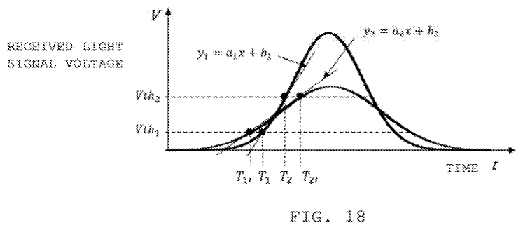

The half-width at half-maximum w has a correlation with inclinations a₁ and a₂ of approximate straight lines y₁=a₁x+b₁ and y₂=a₂x+b₂ obtained based on the two threshold voltages Vth₁ and Vth₂, as shown in FIG. 18. The half-width at half-maximum w can be obtained by a table indicating a relationship between the inclinations of the two threshold voltages and the half-width at half-maximum w being experimentally compiled in advance.

Consequently, by assuming that the received light signal waveform is a Gaussian distribution, a wave height value can be calculated by a wave height value derived from one threshold voltage being corrected in accordance with an inclination, using at least one item of information from among the inclination of the rise and the inclination of the fall of the received light signal waveform.

A case wherein the received light signal waveform is assumed to be a Gaussian function has been described in this embodiment, but, for example, a Lorentz function or a Voigt function may be used as a function other than a Gaussian function.

In this way, the object detecting device according to the third embodiment is such that by assuming that the received light signal waveform corresponds to a specific distribution function, a wave height value can be calculated with high accuracy, in the same way as in the first embodiment, by a wave height value derived from one threshold voltage being corrected using at least one item of information from among the inclination of the rise and the inclination of the fall of the received light signal waveform.

In this embodiment, a case wherein a laser beam is used as a search wave has been described, but the method whereby a wave height value is obtained from a reflected wave can also be applied to a case wherein another light source (for example, an LED), an ultrasonic wave, or an electromagnetic wave is used. Also, in addition to a preceding vehicle, the detection target object may be an obstacle, or a display marked on a road surface. Also, a search direction may be ahead, behind, or beside the own vehicle.

Although the present application is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments.

It is therefore understood that numerous modifications which have not been exemplified can be devised without departing from the scope of the present application. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. An object detecting device, comprising:
a search wave output unit that emits a pulse-form search wave toward a detection target object;
a reflected wave receiving unit that receives a reflected wave that is the search wave reflected by the detection target object;
a distance calculating unit that calculates a distance to the detection target object based on a time required from an emission of the search wave until a reception of the reflected wave; and
a wave height value calculating unit that obtains an approximate straight line based on an inclination of a rise and/or a fall of a waveform of the reflected wave at a set threshold, and calculates a wave height value of the reflected wave based on the approximate straight line.

2. The object detecting device according to claim 1, wherein the wave height value is calculated based on an intersection point of the approximate straight line of the rise and the approximate straight line of the fall obtained based on two of the threshold.

3. The object detecting device according to claim 1, wherein the wave height value is calculated based on a pulse width of the reflected wave at one of the thresholds and on the approximate straight line.

4. The object detecting device according to claim 1, wherein whether or not a received output of the reflected wave is saturated is determined based on a difference between a time of the rise and a time of the fall of the waveform of the reflected wave at the threshold.

5. The object detecting device according to claim 2, wherein whether or not a received output of the reflected wave is saturated is determined based on a difference between a time of the rise and a time of the fall of the waveform of the reflected wave at the threshold.

6. The object detecting device according to claim 3, wherein whether or not a received output of the reflected wave is saturated is determined based on a difference between a time of the rise and a time of the fall of the waveform of the reflected wave at the threshold.

7. The object detecting device according to claim 4, wherein, when it is determined that the received output of the reflected wave is saturated, the wave height value is corrected using an output saturation reset time of a receiving device that receives the reflected wave.

8. The object detecting device according to claim 5, wherein, when it is determined that the received output of the reflected wave is saturated, the wave height value is corrected using an output saturation reset time of a receiving device that receives the reflected wave.

9. The object detecting device according to claim 6, wherein, when it is determined that the received output of the reflected wave is saturated, the wave height value is corrected using an output saturation reset time of a receiving device that receives the reflected wave.
